(19) United States
(12) Patent Application Publication
(10) Pub. No.: US 2014/0214390 A1
(43) Pub. Date: Jul. 31, 2014

(54) BIOLOGICAL SIMULATION METHOD AND BIOLOGICAL SIMULATION DEVICE

(71) Applicants: The University of Tokyo, Tokyo (JP); FUJITSU LIMITED, Kawasaki-shi (JP)

(72) Inventors: Takumi WASHIO, Tokyo (JP); Toshiaki Hisada, Tokyo (JP); Seiryo Sugiura, Tokyo (JP); Jun-ichi Okada, Tokyo (JP); Akihito Takahashi, Tokyo (JP); Kazunori Yoneda, Suginami (JP); Hiroyuki Matsunaga, Fukuoka (JP)

(73) Assignees: The University of Tokyo, Tokyo (JP); FUJITSU LIMITED, Kawasaki-shi (JP)

(21) Appl. No.: 14/164,717

(22) Filed: Jan. 27, 2014

(30) Foreign Application Priority Data
Jan. 31, 2013 (JP) 2013-017680

(51) Int. Cl. G06F 19/12

(52) U.S. Cl. CPC G06F 19/12
USPC 703/11

(57) ABSTRACT

A biological simulation method includes calculating a behavior of a material contained in a cell of an organ of a biological body, calculating a behavior of the cell based on the calculated behavior of the material, calculating a behavior of the organ based on the calculated behavior of the cell, reflecting the calculated behavior of the organ to the behavior of the cell, and reflecting the behavior of the cell to which the behavior of the organ has been reflected to the behavior of the material.

### CROSS-REFERENCE TO RELATED APPLICATION(S)

This application is based upon and claims the benefit of priority of the prior Japanese Patent Application No. 2013-017680, filed on Jan. 31, 2013, the entire contents of which are incorporated herein by reference.

### FIELD

The embodiments discussed herein are directed to a biological simulation method and a biological simulation device.

### BACKGROUND

Huge knowledge has been obtained about scales of organs, cells, and materials contained in a cell in a biological body with advancement of medical measurement techniques. It is, however, difficult for even experts to understand and predict relations among the scales of the organs, the cells, and the materials contained in a cell; for example, influences of behaviors of the cells and the organs on each other. For example, as for the heart, there are cardiac diseases of which pathological mechanisms have not been explained although responsible genes have been identified by global genetic analysis, such as familial hypertrophic cardiomyopathy.

For coping with this, there are techniques of simulating influences of the behaviors of the cells and the organs on each other. Examples of the techniques include a technique of simulating behaviors of a cardiomyocyte model and a heart model.

For example, see A. Hosoi, T. Washio, J. Okada, Y. Kadooka, K. Nakajima and T. Hisada, A multi-scale heart simulation on massively parallel computers, ACM/IEEE Supercomputing Conference (SC10), 2010.

In the above-mentioned technique of simulating the behaviors of the cardiomyocyte model and the heart model, simulation is performed on a structure contained in the cardiomyocyte, for example, a sarcomere, using an average model. That is, in the technique, the simulation is performed on a small structure contained in the cardiomyocyte, such as the sarcomere, using the average model. This raises a problem in that the simulation result lacks accuracy.

### SUMMARY

According to an aspect of an embodiment, a biological simulation method includes: calculating a behavior of a material contained in a cell of an organ of a biological body; calculating a behavior of the cell based on the calculated behavior of the material; calculating a behavior of the organ based on the calculated behavior of the cell; reflecting the calculated behavior of the organ to the behavior of the cell; and reflecting the behavior of the cell to which the behavior of the organ has been reflected to the behavior of the material.

According to another aspect of an embodiment, a biological simulation method includes: calculating a behavior of a material contained in a cell of an organ of a biological body; calculating a force that is applied to the organ; calculating a behavior of the organ based on the calculated force that is applied to the organ; calculating a behavior of the cell based on the calculated behavior of the material; reflecting the calculated behavior of the organ to the cell; and reflecting the behavior of the cell to which the behavior of the organ has been reflected to the behavior of the material.

According to still another aspect of an embodiment, a biological simulation device includes a first processor and a second processor. The first processor is configured to calculate a behavior of a material contained in a cell of an organ of a biological body, calculate a behavior of the cell based on the calculated behavior of the material, reflect a behavior of the organ to the behavior of the cell, and reflect the behavior of the cell to which the behavior of the organ has been reflected to the behavior of the material. The second processor is configured to calculate a behavior of the organ based on the calculated behavior of the cell.

According to still another aspect of an embodiment, a biological simulation device includes a first operation processor and a second operation processor. The first processor is configured to calculate a behavior of a material contained in a cell of an organ of a biological body, calculate a behavior of the organ based on the calculated force that is applied to the organ, calculate a behavior of the cell based on the calculated behavior of the material, reflect the calculated behavior of the organ to the cell, and reflect the behavior of the cell to which the behavior of the organ has been reflected to the behavior of the material. The second processor is configured to calculate a force that is applied to the organ.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional configuration of a biological simulation device according to a first embodiment;

FIG. 2 is a view illustrating examples of macro models, a meso model, and a micro model;

FIG. 3 is a diagram illustrating an example of condition data;

FIG. 4 is a flowchart illustrating procedures of biological simulation processing in the first embodiment;

FIG. 5 is a flowchart illustrating procedures of simulation processing in the first embodiment;

FIG. 6A is a view illustrating an example of a simulation result of each model at a time step that is displayed on a display unit;

FIG. 6B is a view illustrating an example of a simulation result of each model at a time step that is displayed on the display unit;

FIG. 6C is a view illustrating an example of a simulation result of each model at a time step that is displayed on the display unit;

FIG. 7 is a time chart illustrating an example of execution timings of pieces of processing by a macro processor and a meso-micro processor in the first embodiment;

FIG. 8 is a diagram illustrating an example of a functional configuration of a biological simulation device according to a second embodiment;

FIG. 9 is a flowchart illustrating procedures of simulation processing in the second embodiment;

FIG. 10 is a time chart illustrating an example of execution timings of pieces of processing by a macro processor and a meso-micro processor in the second embodiment; and

FIG. 11 is a diagram illustrating a computer that executes a biological simulation program.

### DESCRIPTION OF EMBODIMENTS

Preferred embodiments of the present invention will be explained with reference to accompanying drawings. Note that the embodiments do not limit disclosed techniques.

### [a] First Embodiment

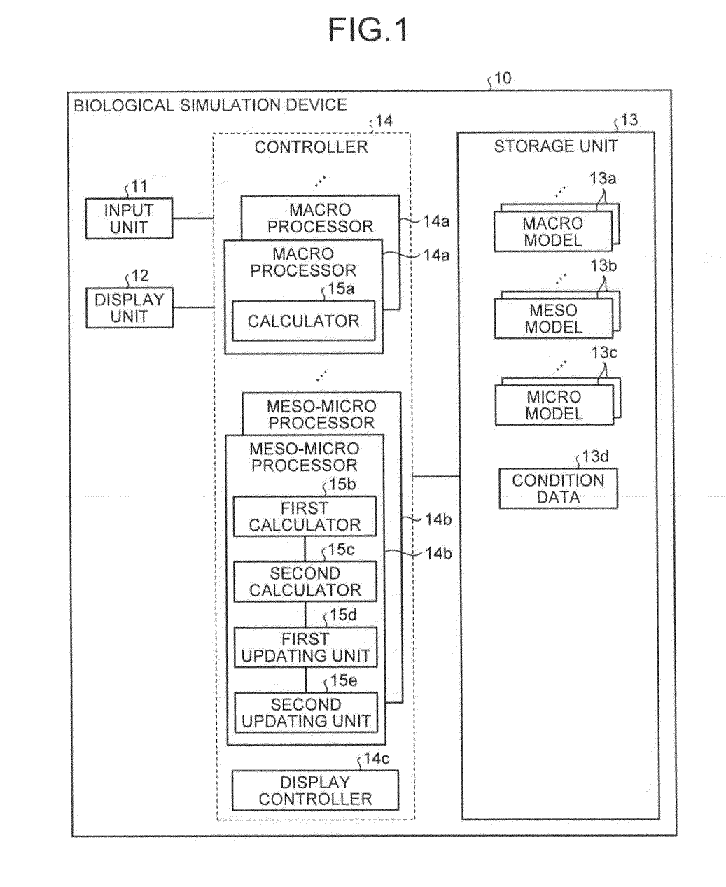

The following describes a biological simulation device according to a first embodiment. FIG. 1 is a diagram illustrating an example of a functional configuration of the biological simulation device in the first embodiment. This biological simulation device 10 includes an input unit 11, a display unit 12, a storage unit 13, and a controller 14.

The input unit 11 inputs various kinds of information to the controller 14. For example, upon receiving an instruction to execute biological simulation processing, which will be described later, from a user, the input unit 11 inputs the received instruction to the controller 14. The input unit 11 is, for example, a keyboard or a mouse.

The display unit 12 displays various kinds of information. For example, the display unit 12 displays a simulation result under control by a display controller 14c, which will be described later.

The storage unit 13 stores therein various types of programs that are executed by the controller 14. The storage unit 13 stores therein macro models 13a, meso models 13b, micro models 13c, and condition data 13d.

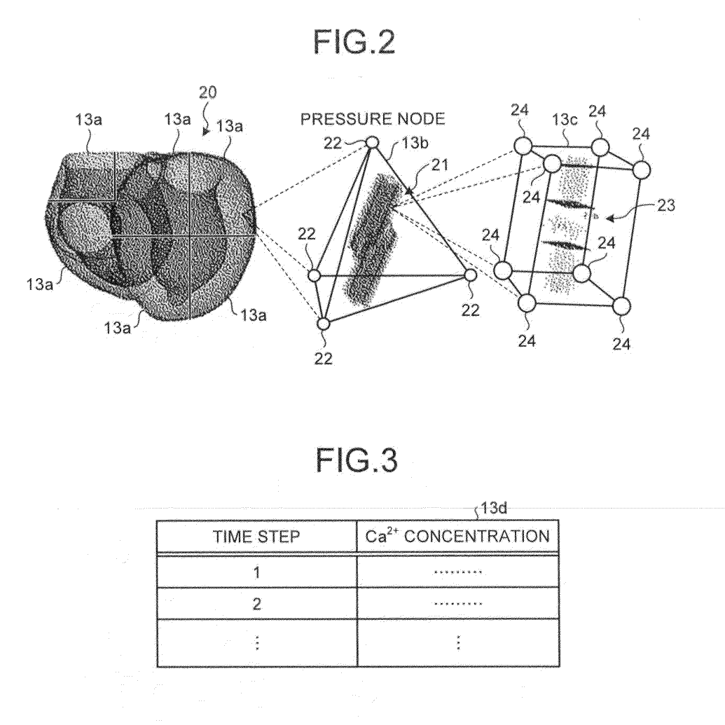

The macro models 13a are models obtained by dividing a model of the entire heart into a plurality of (for example, 10) portions. Note that the heart is an example of an organ of a biological body. The meso models 13b are models of the cardiomyocytes. Note that the cardiomyocyte is an example of a cell. The micro models 13c are models of sarcomeres contained in the cardiomyocyte. Note that the sarcomere is an example of a material contained in the cell. FIG. 2 is a view illustrating examples of the macro models, the meso model, and the micro model. The example of FIG. 2 illustrates the case where a model 20 of the entire heart is divided into a plurality of macro models 13a. A cardiac portion indicated by each of the macro models 13a contains a plurality of cardiomyocytes 21. The meso models 13b are models of the respective cardiomyocytes 21 contained in the macro model 13a. In the example of FIG. 2, each of the meso models 13b is a model having a shape of regular tetrahedron and has four node points 22. The cardiomyocytes indicated by the respective meso models 13b each contain a plurality of sarcomeres 23. The micro models 13c are models of the respective sarcomeres 23 contained in the meso model 13b. In the example of FIG. 2, each of the micro models 13c is a model having a shape of regular hexahedron and has eight node points 24.

The condition data 13d is data indicating conditions when biological simulation is performed. FIG. 3 is a diagram illustrating an example of the condition data. In an example of FIG. 3, the condition data 13d has items of “time step” and “Ca²⁺ concentration”. Time steps of the biological simulation are registered in the item of the “time step”. Concentrations of calcium ion (Ca²⁺) in each cardiomyocyte at the time steps registered in the item of the “time step” are registered in the item of “Ca²⁺ concentration”. That is to say, the condition data 13d as illustrated in FIG. 3 indicates the calcium ion concentration in each cardiomyocyte at each time step.

The storage unit 13 is a storage device exemplified by a semiconductor memory element such as a flash memory, a hard disk, and an optical disk. Note that the storage unit 13 is not limited to the above-mentioned kinds of storage devices and may be a random access memory (RAM), a read only memory (ROM), or the like.

The controller 14 includes an internal memory for storing programs defining various processing procedures and control data, and executes various kinds of processing by the use of them. As illustrated in FIG. 1, the controller 14 includes a plurality of macro processors 14a as second processors, a plurality of meso-micro processors 14b as first processors, and a display controller 14c.

The macro processors 14a correspond to the respective macro models 13a, and each of the macro processors 14a calculates the behavior of the corresponding macro model 13a. The meso-micro processors 14b correspond to the respective meso models 13b, and each of the meso-micro processors 14b calculates the behavior of the corresponding meso model 13b. Furthermore, each of the meso-micro processors 14b calculates the behavior of each of the micro models 13c indicating the respective sarcomeres 23 that are contained in the cardiomyocyte 21 indicated by the corresponding meso model. That is to say, in the embodiment, a plurality of meso models 13b correspond to one macro model 13a, so that a plurality of meso-micro processors 14b correspond to one macro processor 14a. Furthermore, the controller 14 includes one or a plurality of multi-core central processing unit(s) (CPU(s)) having a plurality of cores as processors. Alternatively, the controller 14 may include a plurality of single-core CPUs having one core as the processor. The cores each execute a biological simulation program described later, thereby implementing each part of the macro processors 14a, the meso-micro processors 14b, and the display controller 14c thereon.

Each of the macro processors 14a as the second processor includes a calculator 15a. Each of the meso-micro processors 14b as the first processor includes a first calculator 15b, a second calculator 15c, a first updating unit 15d, and a second updating unit 15e.

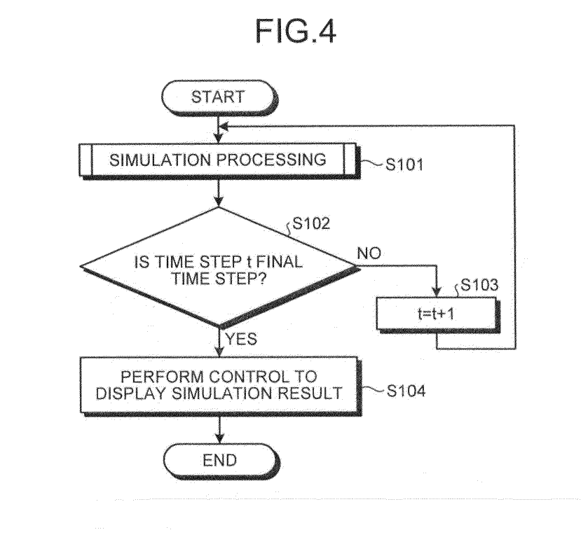

The following describes an example of processing that is executed by the controller 14 with reference to FIG. 4. FIG. 4 is a flowchart illustrating procedures of the biological simulation processing in the first embodiment. The biological simulation processing is executed when the input unit 11 inputs an instruction to execute the biological simulation processing to the controller 14, for example. As illustrated in FIG. 4, the macro processor 14a and the meso-micro processor 14b execute simulation processing (S101). The display controller 14c then determines whether a time step t in the executed simulation processing is a final time step in the biological simulation (S102). When the time step t is not the final time step (No at S102), the display controller 14c increments a value of the time step t by 1 and advances the time step by 1 (S103). The process returns to the processing at S101, and the macro processors 14a and the meso-micro processors 14b execute the simulation processing again.

When the time step t is the final time step (Yes at S102), the display controller 14c performs the following processing. The display controller 14c controls the display unit 12 to display shapes of the macro models 13a, the meso models 13b, and the micro models 13c in accordance with displacement that have been calculated in the simulation processing in the order from the first time step to the final time step (S104).

The following describes an example of the simulation processing in the embodiment. In the embodiment, multi-scale analysis between the macro models 13a and the meso models 13b is performed as follow. That is, a non-linear equation at each time step is linearized to lead to questions (the following equations (1) to (4)) that are solved repeatedly using the Newton-Raphson method.

$$\begin{matrix} {A}_{\tilde{P} , e} \text{:} = {\tilde{P}}^{T} {A}_{F , e} \tilde{P} & ( 1 ) \\ {A}_{C , e} = {B}_{C , e}^{T} {\tilde{G}}^{T} {A}_{F , e} \tilde{G} {B}_{C , e} & ( 2 ) \\ {f}_{C , e} = {B}_{C , e}^{T} {\tilde{G}}^{T} {f}_{F , e} & ( 3 ) \\ [ \begin{matrix}{\sum }_{e} {A}_{\tilde{p} , e} & {\sum }_{e} {\tilde{P}}^{T} {A}_{F , e} \tilde{G} {B}_{C , e} \\ {\sum }_{e} {B}_{C , e}^{T} {\tilde{G}}^{T} {A}_{F , e} \tilde{P} & {C}_{C} + {\sum }_{e} {A}_{C , e}\end{matrix} ] [ \begin{matrix}{\sum }_{e} {x}_{F , e} \\ {x}_{C}\end{matrix} ] = - [ \begin{matrix}{\sum }_{e} {\tilde{P}}^{T} {f}_{F , e} \\ {g}_{C} + {\sum }_{e} {f}_{C , e}\end{matrix} ] & ( 4 )\end{matrix}$$

A_{F,e} is a stiffness matrix (meso element stiffness matrix) corresponding to an element e in the meso model 13b. A_{C,e} is a stiffness matrix (macro element stiffness matrix) corresponding to an element e in the macro model 13a. f_{F,e} is a meso equivalent nodal force corresponding to A_{F,e}. f_{C,e} is a macro equivalent nodal force corresponding to A_{C,e}. x_{F,e} is a solution (meso solution) of the element e in the meso model 13b, for example, a displacement of the element e in the meso model 13b. x_{C} is a solution (macro solution) of the macro model 13a, for example, a displacement of the macro model 13a.

\tilde{G} is an operator for obtaining a stress on a meso coordinate system from the strain of the macro model 13a. B_{C,e} is an operator for obtaining a strain from the displacement of the element e in the macro model 13a.

\tilde{P} is an operator indicating embedding into meso period displacement. C_{C} is a stiffness matrix (macro stiffness matrix) corresponding to the macro model 13a. g_{C} is a macro equivalent nodal force corresponding to C_{C}.

When the equations are solved repeatedly using the Newton-Raphson method, a vector χ_{C,e} called a characteristic displacement mode is calculated in accordance with the following equation (5).

A_{\acute{P},e}χ_{C,e}=\tilde{P}^{T}A_{F,e}\tilde{G} (5)

A Schur complement S_{C,e} is calculated in accordance with the following equation (6) using nature that the meso solutions x_{F,e} give no influence on one another directly.

S_{C,e}=A_{C,e}−B_{C,e}^{T}\tilde{G}^{T}A_{F,e}\tilde{P}χ_{C,e}B_{C,e} (6)

Subsequently, block lower triangle matrix upper triangle matrix (LU) factorization is performed using S_{C,e}, in the manner as indicated by the following equation (7). The block LU factorization is a method of factorizing the square matrix into a product of a lower triangular block matrix and an upper triangular block matrix in the idea that a square matrix is a group of sub-matrices (blocks). The lower triangular block matrix indicates a matrix that all the upper-right blocks relative to a diagonal block are null matrices, and the upper triangular block matrix indicates a matrix that all the lower-left blocks relative to the diagonal block are null matrices. Noted that the LU factorization can be also considered as block LU factorization when the size of all the block matrices is set to 1×1.

$$\tilde{M} = [ \begin{matrix}{A}_{\tilde{P} , e} & {\tilde{P}}^{T} {A}_{F , e} \tilde{G} {B}_{C , e} \\ {B}_{C , e}^{T} {\tilde{G}}^{T} {A}_{F , e} \tilde{P} & {A}_{C , e}\end{matrix} ] = [ \begin{matrix}{A}_{\tilde{P} , e} & 0 \\ {B}_{C , e}^{T} {\tilde{G}}^{T} {A}_{F , e} \tilde{P} & {S}_{C , e}\end{matrix} ] [ \begin{matrix}I & {𝒳}_{C , e} {B}_{C , e} \\ 0 & I\end{matrix} ] \qquad ( 7 )$$

When the equation (4) is deformed using the equation (7), the meso solutions x_{F,e} can be calculated, the macro solution x_{C} can be calculated, and the meso solutions x_{F,e} can be updated using the following equations (8) to (11). Specifically, the macro solution x_{C} can be calculated based on the calculation results of the meso solutions x_{F,e}, and the calculation result of the macro solution x_{C} can be reflected to the meso solutions x_{F,e}. When the meso solutions x_{F,e} are calculated using the equation (8), the meso solution x_{F,e} can be calculated independently for each element e of the meso model. Thus, when a core is assigned to each of the meso-micro processors 14b and the cores calculate the meso solutions x_{F,e} in parallel as in the embodiment, the meso solutions x_{F,e} can be calculated at high speed because the meso solutions x_{F,e} are calculated in parallel. The embodiment can therefore provide highly efficient calculation of the meso solutions x_{F,e}.

$$\begin{matrix}{A}_{\tilde{P} , e} {x}_{F , e} = - {\tilde{P}}^{T} {f}_{F , e} & ( 8 ) \\ {b}_{C , e} := {f}_{C , e} + {B}_{C , e}^{T} {\tilde{G}}^{T} {A}_{F , e} \tilde{P} {x}_{F , e} & ( 9 ) \\ ( {C}_{C} + {\sum }_{e} {S}_{C , e} ) {x}_{C} = - {g}_{C} - {\sum }_{e} {b}_{C , e} & ( 10 ) \\ {x}_{F , e} := {x}_{F , e} - {𝒳}_{C , e} {B}_{C , e} {x}_{C} & ( 11 )\end{matrix}$$

In the embodiment, also in the multi-scale analysis between the meso models 13b and the micro models 13c, a non-linear equation at each step is linearized to lead to questions (the following equations (12) to (15)) that are solved repeatedly using the Newton-Raphson method.

$$\begin{matrix} {A}_{P , e} := {P}^{T} {A}_{M , e} P & ( 12 ) \\ {A}_{F , e} = {B}_{F , e}^{T} {G}^{T} {A}_{M , e} {GB}_{F , e} & ( 13 ) \\ {f}_{F , e} = {B}_{F , e}^{T} {G}^{T} {f}_{M , e} & ( 14 ) \\ [ \begin{matrix}{\sum }_{e} {A}_{P , e} & {\sum }_{e} {P}^{T} {A}_{M , e} {GB}_{F , e} \\ {\sum }_{e} {B}_{F , e}^{T} {G}^{T} {A}_{M , e} & {PC}_{F} + {\sum }_{e} {A}_{F , e}\end{matrix} ] [ \begin{matrix}{\sum }_{e} {x}_{M , e} \\ {x}_{F}\end{matrix} ] = - [ \begin{matrix}{\sum }_{e} {P}^{T} {f}_{M , e} \\ {g}_{F} + {\sum }_{e} {f}_{F , e}\end{matrix} ] & ( 15 )\end{matrix}$$

A_{M,e} is a stiffness matrix (micro element stiffness matrix) corresponding to an element e of the micro model 13c. f_{M,e} is a micro equivalent nodal force. x_{M,e} is a solution (micro solution) of the element e in the micro model 13c, for example, a displacement of the element e in the micro model 13c. G is an operator for obtaining a stress on a micro coordinate system from a strain of the meso model 13b. B_{F,e} is an operator for obtaining a strain from the displacement of the element e in the meso model 13b. P is an operator indicating embedding into meso period displacement. C_{F} is a stiffness matrix (meso stiffness matrix) of the meso model 13b. g_{F} is a meso equivalent nodal force corresponding to C_{F}.

When the equations are solved repeatedly using the Newton-Raphson method, a vector χ_{F,e} called characteristic displacement modes are calculated in accordance with the following equation (16).

A_{F,e}χ_{F,e}=P^{T}A_{M,e}G (16)

A Schur complements S_{F,e} is calculated in accordance with the following equation (17) using nature that the micro solutions x_{M,e} give no influence on one another directly.

S_{F,e}=A_{F,e}−B_{F,e}^{T}G^{T}A_{M,e}Pχ_{F,e}B_{F,e} (17)

Subsequently, LU factorization is performed using S_{F,e} in the manner as indicated by the following equation (18).

$$M = [ \begin{matrix}{A}_{P , e} & {P}^{T} {A}_{M , e} {GB}_{F , e} \\ {B}_{F , e}^{T} {G}^{T} {A}_{M , e} P & {A}_{F , e}\end{matrix} ] = [ \begin{matrix}{A}_{P , e} & 0 \\ {B}_{F , e}^{T} {G}^{T} {A}_{M , e} P & {S}_{F , e}\end{matrix} ] [ \begin{matrix}I & {𝒳}_{F , e} {B}_{F , e} \\ 0 & I\end{matrix} ] \qquad ( 18 )$$

When the equation (15) is deformed using the equation (18), the micro solutions x_{M,e} can be calculated, the meso solution x_{F,e} can be calculated, and the micro solutions x_{M,e} can be updated using the following equations (19) to (22). Specifically, the meso solution x_{F,e} is calculated based on the calculation results of the micro solutions x_{M,e}, and the calculation result of the meso solution x_{F,e} can be reflected to the micro solutions x_{M,e}.

$$\begin{matrix}{A}_{P , e} {x}_{M , e} = - {P}^{T} {f}_{M , e} & ( 19 ) \\ {b}_{F , e} \text{:} = {f}_{F , e} + {B}_{F , e}^{T} {G}^{T} {A}_{M , e} {Px}_{M , e} S & ( 20 ) \\ ( {C}_{F} + {\sum }_{e} {S}_{F , e} ) {x}_{F} = - {g}_{F} - {\sum }_{e} {b}_{F , e} & ( 21 ) \\ {x}_{M , e} \text{:} = {x}_{M , e} - {𝒳}_{F , e} {B}_{F , e} {x}_{F} & ( 22 )\end{matrix}$$

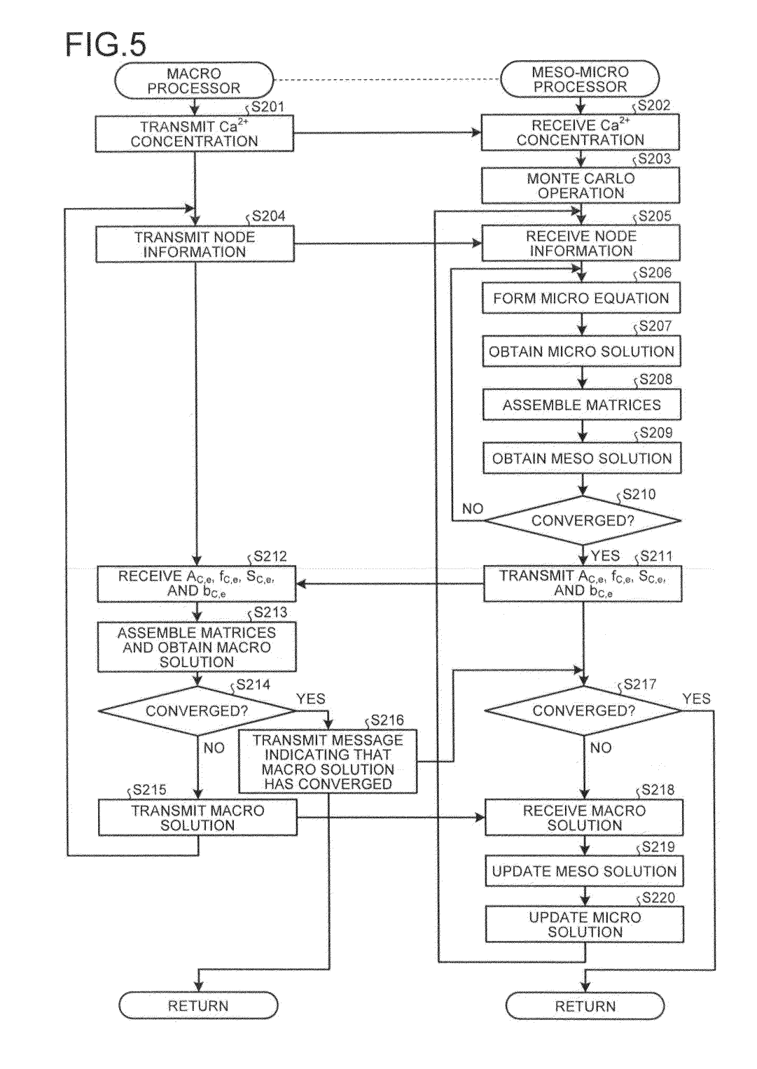

Described is an example of the above-mentioned simulation processing that is executed by the macro processors 14a and the meso-micro processors 14b. FIG. 5 is a flowchart illustrating procedures of the simulation processing in the first embodiment. In the simulation processing in the embodiment, information transfer occurs between the macro processors 14a and the respective meso-micro processors 14b. Note that the example of FIG. 5 illustrates processing that is executed by one macro processor 14a and processing that is executed by one meso-micro processor 14b for the convenience of description.

As illustrated in FIG. 5, the calculator 15a of the macro processor 14a acquires the calcium ion concentration for each of the cardiomyocytes at the current time step t from the condition data 13d and transmits the acquired calcium ion concentrations to the respective meso-micro processors 14b corresponding to the respective cardiomyocytes (S201).

The first calculator 15b of each of the meso-micro processors 14b receives the calcium ion concentration transmitted from the calculator 15a (S202). The first calculator 15b then calculates the contraction force and the like for each of the micro models 13c using the Monte Carlo method (S203). The calculator 15a transmits node information including the pressures of respective nodes to each of the meso-micro processors 14b (S204).

Subsequently, the first calculator 15b receives the node information transmitted from the calculator 15a (S205). The first calculator 15b then calculates the vectors χ_{F,e} using the equation (16) (S206). The first calculator 15b calculates the Schur complement S_{F,e} in accordance with the equation (17) at S206. Thereafter, the first calculator 15b performs the LU factorization using S_{F,e} to obtain the equation (18) at S206. The first calculator 15b deforms the equation (15) using the equation (18) to obtain the equations (19) to (22) at S206. The first calculator 15b then calculates b_{F,e} in accordance with the equation (20) at S206.

Subsequently, the first calculator 15b calculates the micro solutions x_{M,e} in accordance with the equation (19) (S207).

The second calculator 15c of the meso-micro processor 14b calculates the vector χ_{C,e} using the equation (5) (S208). The second calculator 15c calculates the Schur complement S_{C,e} in accordance with the equation (6) at S208. Thereafter, the second calculator 15c performs the LU factorization using S_{C,e} to obtain the equation (7) at S208. The second calculator 15c then deforms the equation (4) using the equation (7) to obtain the equation (8), the equation (9), and the equation (11) at S208. The second calculator 15c calculates b_{C,e} in accordance with the equation (9) at S208.

Subsequently, the second calculator 15c calculates the meso solutions x_{F,e} of the respective elements of the meso model 13b in accordance with the equation (8), and calculates the meso solution x_{F} of the meso model 13b from the meso solutions x_{F,e} of the elements of the meso model 13b in accordance with the equation (21) (S209). The second calculator 15c then determines whether the meso solution x_{F} has converged (S210). When the meso solution x_{F} has not converged (No at S210), the process returns to S206. When the meso solution x_{F} has converged (Yes at S210), the second calculator 15c transmits A_{C,e} obtained as the result of calculation of the equation (2), f_{C,e} obtained as the result of calculation of the equation (3), the Schur complement S_{C,e}, and b_{C,e} to the macro processor 14a (S211).

Upon receiving A_{C,e}, f_{C,e}, S_{C,e}, and b_{C,e} from all the meso-micro processors 14b corresponding to the macro processor 14a (S212), the calculator 15a of the macro processor 14a deforms the equation (4) using the equation (7) to obtain the equation (10) (S213). The calculator 15a calculates the macro solution x_{C} in accordance with the equation (10) at S213. The calculator 15a then determines whether the macro solution x_{C} has converged (S214). When the macro solution x_{C} has not converged (No at S214), the calculator 15a transmits the macro solution x_{C} to each of the meso-micro processors 14b (S215). The process returns to S204, and the calculator 15a updates node information including the pressures and the like of the respective nodes and transmits the updated node information to each of the meso-micro processors 14b. When the macro solution x_{C} has converged (Yes at S214), the calculator 15a transmits a message indicating that the macro solution x_{C} has converged to each of the meso-micro processors 14b (S216), and stores a processing result in the internal memory. The process then returns.

When the processing at S211 is executed, the first updating unit 15d of each of the meso-micro processors 14b determines whether it has received the message indicating that the macro solution x_{C} has converged so as to determine whether the macro solution x_{C} has converged (S217). Upon receiving the message indicating that the macro solution x_{C} has converged, the first updating unit 15d determines that the macro solution x_{C} has converged. Upon receiving no message indicating that the macro solution x_{C} has converged, the first updating unit 15d determines that the macro solution x_{C} has not converged.

When the macro solution x_{C} has not converged (No at S217), the first updating unit 15d receives the macro solution x_{C} from the calculator 15a (S218), and substitutes the received macro solution x_{C} into the equation (11) to update the meso solutions x_{F,e} (S219).

Subsequently, the second updating unit 15e of each of the meso-micro processors 14b substitutes the meso solution x_{F} into the equation (22) to update the micro solutions x_{M,e} (S220), and stores a processing result in the internal memory. The process then returns.

As described above, the biological simulation device 10 according to the embodiment calculates the behavior of the sarcomeres, which are indicated by the micro models 13c, contained in each of the cardiomyocytes. The biological simulation device 10 calculates the behavior of the cardiomyocytes indicated by the meso models 13b based on the calculated behaviors of the sarcomeres. Subsequently, the biological simulation device 10 calculates the behavior of the heart indicated by the macro models 13a based on the calculated behaviors of the cardiomyocytes. Thereafter, the biological simulation device 10 updates the behaviors of the cardiomyocytes indicated by the meso models 13b based on the calculated behavior of the heart. The biological simulation device 10 then updates the behaviors of the sarcomeres indicated by the micro models 13c based on the updated behaviors of the cardiomyocytes. Thus, the biological simulation device 10 performs simulation of the behavior using models of three levels including the macro models 13a indicating the entire heart, the meso models 13b indicating the cardiomyocytes, and the micro models 13c indicating the sarcomeres. Thus, the biological simulation device 10 can perform accurate simulation, that is, multi-scale analysis of three levels. This enables the biological simulation device 10 to provide an accurate simulation result.

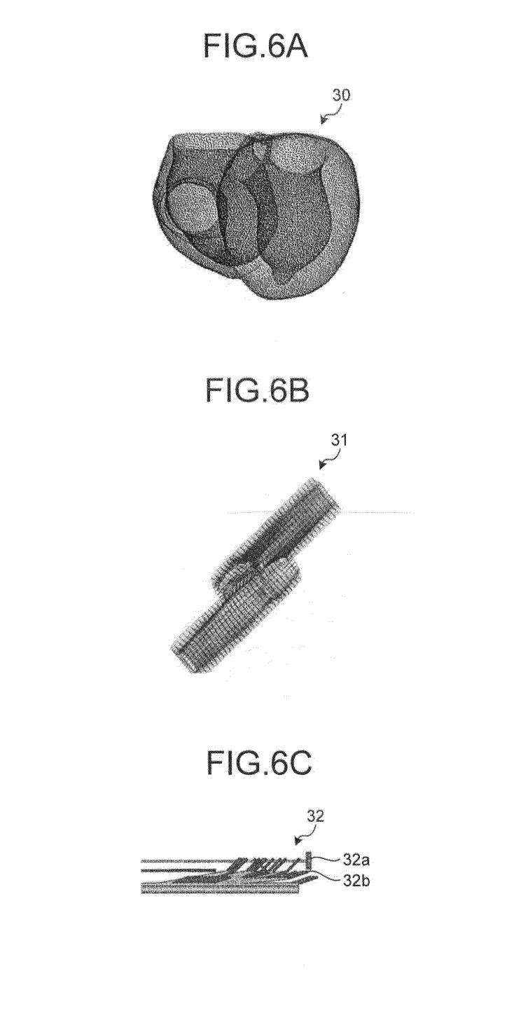

FIG. 6A to FIG. 6C illustrate examples of a simulation result of each model at a certain time step that is displayed on the display unit. FIG. 6A illustrates the shape of a heart 30 indicated by the macro models 13a at a certain time step that is displayed on the display unit 12. FIG. 6B illustrates the shape of a cardiomyocyte 31 indicated by the meso model 13b at a certain time step that is displayed on the display unit 12. FIG. 6C illustrates the shape of a sarcomere 32 indicated by the micro model 13c at a certain time step that is displayed on the display unit 12. As illustrated in FIG. 6C, with the biological simulation device 10 according to the embodiment, a structure of a portion is visible on which a cross bridge of actin filaments 32a and myosin heads 32b is finely formed.

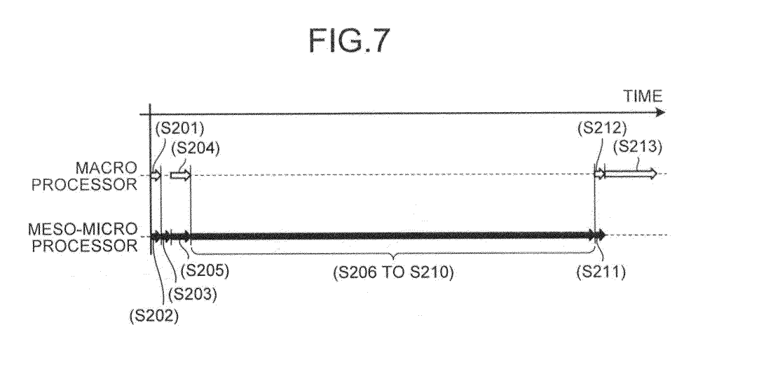

The following describes an example of execution timings of pieces of processing by the macro processor 14a and the meso-micro processor 14b in the first embodiment. FIG. 7 is a time chart illustrating an example of the execution timings of the pieces of processing by the macro processor and the meso-micro processor in the first embodiment. The example of FIG. 7 illustrates times and execution timings of the processing at the steps S that are executed by the macro processor 14a and times and execution timings of the processing at the steps S that are executed by the meso-micro processor 14b. The time chart illustrated in FIG. 7 indicates that the macro processor 14a do not execute processing and is in a standby state while the meso-micro processor 14b execute the processing at S206 to S210.

### [b] Second Embodiment

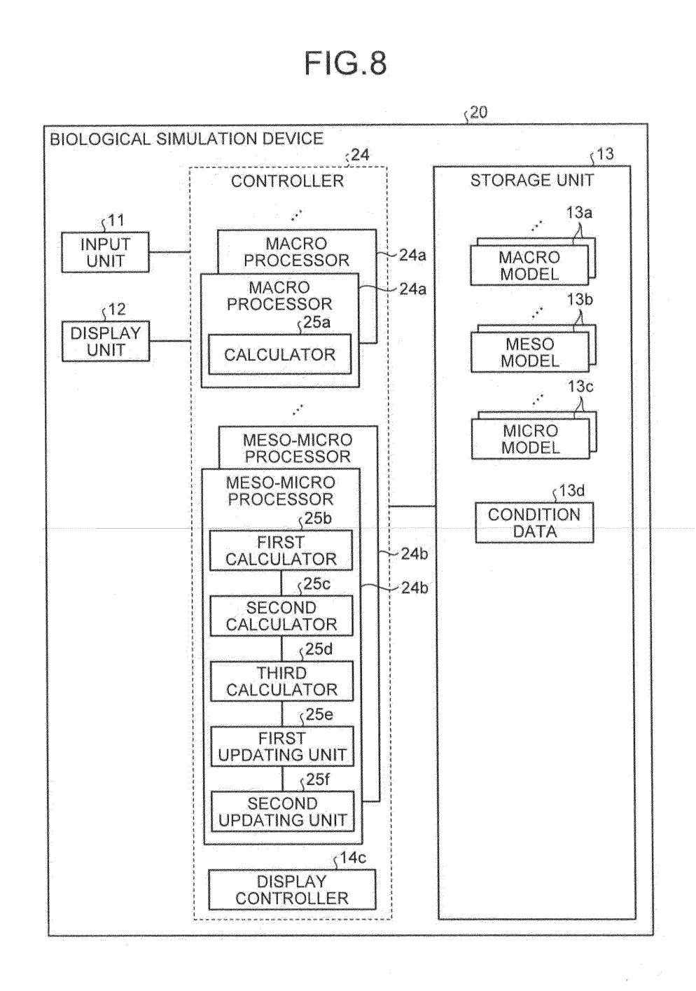

As a second embodiment, the following describes a biological simulation device that can reduce the time during which the macro processor is in the standby state. The same reference numerals as those in the first embodiment denote the same components, and description thereof is omitted in some cases. FIG. 8 is a diagram illustrating an example of a functional configuration of the biological simulation device according to the second embodiment. This biological simulation device 20 includes an input unit 11, a display unit 12, a storage unit 13, and a controller 24.

The input unit 11, the display unit 12, and the storage unit 13 have the same configurations as those in the first embodiment, so that description thereof is omitted.

The controller 24 includes an internal memory for storing programs defining various processing procedures and control data, and executes various pieces of processing by the use of them. As illustrated in FIG. 8, the controller 24 includes a plurality of macro processors 24a, a plurality of meso-micro processors 24b, and a display controller 14c.

The macro processors 24a correspond to the macro models 13a, respectively, and each of the macro processors 24a calculates the behavior of the corresponding macro model 13a. The meso-micro processors 24b correspond to the meso models 13b, respectively, and each of the meso-micro processors 24b calculates the behavior of the corresponding meso model 13b. Furthermore, each of the meso-micro processors 24b calculates the behaviors of the respective micro models 13c indicating the respective sarcomeres 23 that are contained in the cardiomyocyte 21 indicated by the corresponding meso model. That is to say, in the embodiment, a plurality of meso models 13b correspond to one macro model 13a, so that a plurality of meso-micro processors 24b correspond to one macro processor 24a. Furthermore, the controller 24 includes a plurality of multi-core CPUs. The cores each execute a biological simulation program described later, thereby functioning each part of the macro processors 24a, the meso-micro processors 24b, and the display controller 14c thereon.

Each of the macro processors 24a includes a calculator 25a. Each of the meso-micro processors 24b includes a first calculator 25b, a second calculator 25c, a third calculator 25d, a first updating unit 25e, and a second updating unit 25f.

The biological simulation device 20 according to the second embodiment executes the biological simulation processing illustrated in the flowchart in the above-mentioned example of FIG. 4 as in the first embodiment, so that description of the biological simulation processing is omitted. The simulation processing in the second embodiment is different from the simulation processing in the first embodiment. The following describes an example of the simulation processing in the second embodiment. There are different points between the simulation processing in the second embodiment and the simulation processing in the first embodiment, which will be described below. In the second embodiment, the following equation (23) is used instead of the equation (7) in the first embodiment. The equation (23) is an equation as a result of performing approximate LU factorization.

$$\tilde{N} = [ \begin{matrix}{A}_{\tilde{P} , e} & 0 \\ 0 & {S}_{C , e}\end{matrix} ] [ \begin{matrix}I & {𝒳}_{C , e} {B}_{C , e} \\ 0 & I\end{matrix} ] = [ \begin{matrix}{A}_{\tilde{P} , e} & {\tilde{P}}^{T} {A}_{F , e} \tilde{G} {B}_{C , e} \\ 0 & {A}_{C , e}\end{matrix} ] \qquad ( 23 )$$

Furthermore, while b_{C,e} is calculated using the equation (9) at S208 in the first embodiment, b_{C,e} is not calculated in the second embodiment. While the macro solution x_{C} is calculated using the equation (10) at S213 in the first embodiment, the macro solution x_{C} is calculated using the following equation (24) instead of the equation (10) in the second embodiment.

$$( {C}_{C} + {\sum }_{e} {S}_{C , e} ) {x}_{C} = - {g}_{C} - {\sum }_{e} {f}_{C , e} \qquad ( 24 )$$

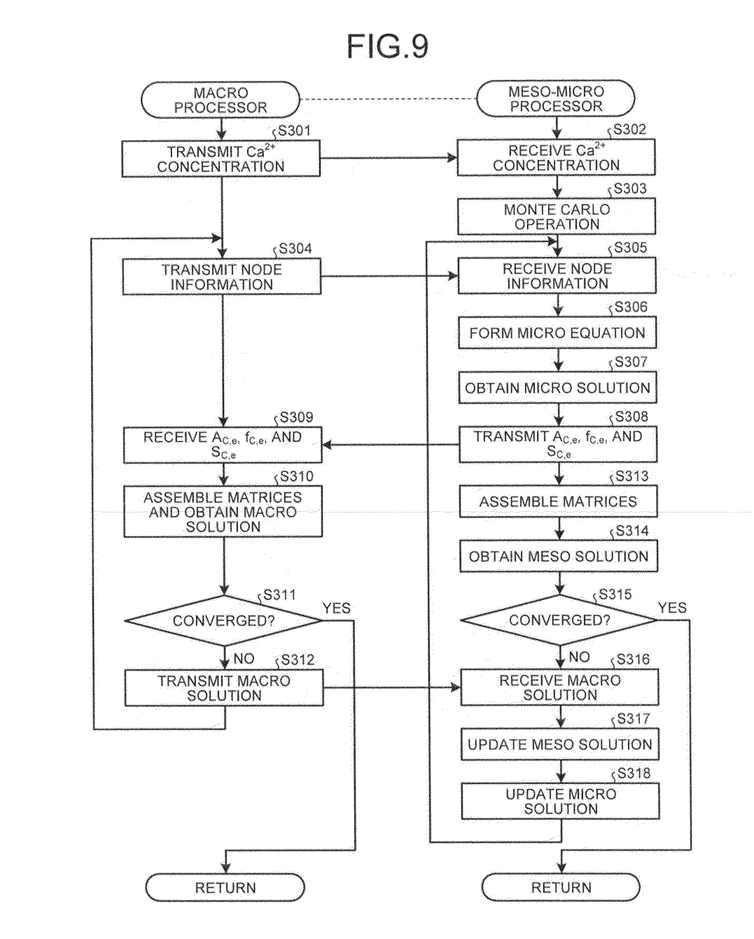

The following describes an example of the above-mentioned simulation processing that is executed by the macro processors 24a as second processors and the meso-micro processors 24b as first processors. FIG. 9 is a flowchart illustrating procedures of the simulation processing in the second embodiment. Also in the simulation processing in the second embodiment, information transfer occurs between the macro processors 24a and the respective meso-micro processors 24b. Note that the example of FIG. 9 illustrates processing that is executed by one macro processor 24a and processing that is executed by one meso-micro processor 24b for the convenience of description.

As illustrated in FIG. 9, the calculator 25a of the macro processor 24a acquires the calcium ion concentrations of the respective cardiomyocytes at the current time step t from the condition data 13d and transmits the acquired calcium ion concentrations to the respective meso-micro processors 24b corresponding to the respective cardiomyocytes (S301).

The first calculator 25b of each of the meso-micro processors 24b receives the calcium ion concentration transmitted from the calculator 25a (S302). The first calculator 25b calculates the contraction force and the like for each of the micro models 13c using the Monte Carlo method (S303). The calculator 25a transmits node information including the pressures of respective node to each of the meso-micro processors 24b (S304).

Subsequently, the first calculator 25b receives the node information transmitted from the calculator 25a (S305). The first calculator 25b then calculates the vectors χ_{F,e} using the equation (16) (S306). The first calculator 25b calculates the Schur complement S_{F,e} in accordance with the equation (17) at S306. Thereafter, the first calculator 25b performs the LU factorization using S_{F,e} to obtain the equation (18) at S306. The first calculator 25b deforms the equation (15) using the equation (18) to obtain the equations (19) to (22) at S306. The first calculator 25b then calculates b_{F,e} in accordance with the equation (20) at S306.

Subsequently, the first calculator 25b calculates the micro solutions x_{M,e} in accordance with the equation (19) (S307). The second calculator 25c of each of the meso-micro processors 24b calculates the vector χ_{C,e} using the equation (5) at S307. The second calculator 25c calculates the Schur complement S_{C,e} in accordance with the equation (6) at S307. Thereafter, The second calculator 25c performs the LU factorization using S_{C,e} to obtain the equation (23) at S307. The third calculator 25d of each of the meso-micro processors 24b calculates f_{C,e} using the equation (3).

Subsequently, the third calculator 25d transmits A_{C,e} obtained as a result of the calculation of the equation (2), f_{C,e} as a result of the calculation of the equation (3), and the Schur complement S_{C,e} to the macro processor 24a (S308).

Upon receiving A_{C,e}, f_{C,e} and S_{C,e} from all the meso-micro processors 24b corresponding to the macro processor 24a (S309), the calculator 25a of the macro processor 24a deforms the equation (4) using the equation (23) to obtain the equation (24) (S310). The calculator 25a calculates the macro solution x_{C} in accordance with the equation (24) at S310. The calculator 25a then determines whether the macro solution x_{C} has converged (S311). When the macro solution x_{C} has not converged (No at S311), the calculator 25a transmits the macro solution x_{C} to each of the meso-micro processors 24b (S312). The process returns to S304, and the calculator 25a updates node information including the pressures and the like of respective nodes and transmits the updated node information to each of the meso-micro processors 24b. When the macro solution x_{C} has converged (Yes at S311), the calculator 25a stores a processing result in the internal memory. The process then returns.

When the processing at 308 is executed, the second calculator 25c deforms the equation (4) using the equation (23) to obtain the equation (8) and the equation (11) (S313).

The second calculator 25c calculates the meso solutions x_{F,e} of the respective elements of the meso model 13b in accordance with the equation (8), and calculates the meso solution x_{F} of the meso model 13b from the meso solutions x_{F,e} of the respective elements of the meso model 13b in accordance with the equation (21) (S314). The second calculator 25c then determines whether the meso solution x_{F} has converged (S315). When the meso solution x_{F} has not converged (No at S315), the first updating unit 25e of each of the meso-micro processors 24b receives the macro solution x_{C} from the calculator 25a (S316), and substitutes the received macro solution x_{C} into the equation (11) to update the meso solutions x_{F,e} (S317).

Subsequently, the second updating unit 25f of each of the meso-micro processors 24b substitutes the meso solution x_{F} into the equation (22) to update the micro solutions x_{M,e} (S318), and stores a processing result in the internal memory. The process then returns.

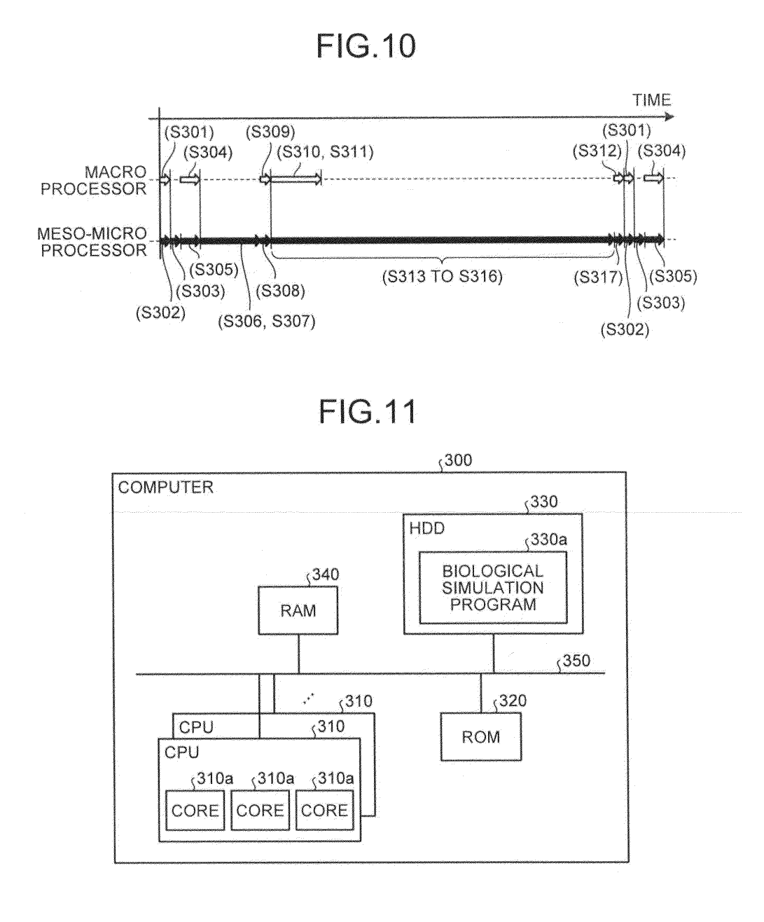

The following describes an example of execution timings of pieces of processing by the macro processor 24a and the meso-micro processor 24b in the second embodiment. FIG. 10 is a time chart illustrating an example of the execution timings of pieces of processing by the macro processor and the meso-micro processor in the second embodiment. The example of FIG. 10 illustrates times and execution timings of the processing at the steps S that are executed by the macro processor 24a and times and execution timings of the processing at the steps S that are executed by the meso-micro processor 24b. In the embodiment, the equation (4) is deformed by the use of the following equation (23) instead of the equation (7) in the first embodiment to obtain an equation (24). In the embodiment, the macro solution x_{C} is calculated using the equation (24). For this reason, as illustrated in FIG. 10, the macro processor 24a can execute the processing at S310 and S311 while the meso-micro processor 24b executes the processing at S206 to S210. That is to say, in the embodiment, it is possible to execute the processing of calculating the meso solution x_{F} by the meso-micro processor 24b and the processing of calculating the macro solution x_{C} by the macro processor 24a in parallel. As a result, the biological simulation device 20 according to the second embodiment can prevent increase in the calculation time. Furthermore, the biological simulation device 20 according to the embodiment can prevent lowering of the utilization rate of the cores of the CPU.

As described above, the biological simulation device 20 according to the embodiment calculates the behavior of the sarcomeres, which are indicated by the micro models 13c, contained in each of the cardiomyocytes. The biological simulation device 20 calculates a force that is applied to the heart indicated by the macro model 13a. The biological simulation device 20 then calculates the behavior of the heart based on the calculated force. Subsequently, the biological simulation device 20 calculates the behavior of the cardiomyocytes indicated by the meso models 13b based on the calculated behaviors of the sarcomeres. Thereafter, the biological simulation device 20 updates the behaviors of the cardiomyocytes indicated by the meso models 13b based on the calculated behavior of the heart. The biological simulation device 20 then updates the behaviors of the sarcomeres indicated by the micro models 13c based on the updated behaviors of the cardiomyocytes. Thus, the biological simulation device 20 performs simulation of the behavior using models of three levels including the macro models 13a indicating the entire heart, the meso models 13b indicating the cardiomyocytes, and the micro models 13c indicating the sarcomeres. Thus, the biological simulation device 20 can perform accurate simulation, that is, multi-scale analysis of three levels. This enables the biological simulation device 20 to provide an accurate simulation result.

Furthermore, as described above, with the biological simulation device 20 in the second embodiment, the macro processor 24a can execute the processing at S310 and S311 while the meso-micro processor 24b executes the processing at S206 to S210. That is to say, in the second embodiment, it is possible to execute the processing of calculating the meso solution x_{F} by the meso-micro processor 24b and the processing of calculating the macro solution x_{C} by the macro processor 24a in parallel. This enables the biological simulation device 20 according to the second embodiment to prevent increase in the calculation time. Furthermore, the biological simulation device 20 according to the second embodiment can prevent lowering of the utilization rate of the cores of the CPU.

Although the embodiments relating to the disclosed device have been described hereinbefore, the device of the invention may be executed in various different modes other than the above-mentioned embodiments. The following describes other embodiments that are encompassed in the invention.

For example, although one meso-micro processor 14b or 24b is executed on one core and one macro processor 14a or 24a is executed on one core in the above-mentioned first embodiment and second embodiment, the disclosed device is not limited thereto. For example, a plurality of meso-micro processors 14b or 24b may be executed on one core. A plurality of macro processors 14a or 24a may be executed on one core. Alternatively, the meso-micro processor 14b or 24b and the macro processor 14a or 24a may be executed on one core.

The entire processing or a part of the processing described in the above-mentioned embodiments that is performed automatically may be performed manually. The entire processing or a part of the processing described in the above-mentioned embodiments that is performed manually can be performed automatically with a known method.

The processing at the steps in the processes described in the above-mentioned embodiments can be subdivided into small pieces or be compiled as appropriate depending on various loads or usage conditions. Any of the steps can be omitted.

Furthermore, the order of the pieces of processing at the steps in the processes described in the above-mentioned embodiments can be changed depending on various loads or usage conditions.

The components of the devices in the drawings are illustrated conceptually in function and are not necessarily configured as illustrated in the drawings physically. That is to say, the specific state of separation and integration of the devices are not limited to those illustrated in the drawings. The whole or a part thereof can be separated or integrated functionally or physically based on any desired unit depending on various loads or usage conditions.

Biological Simulation Program

Various pieces of processing in the biological simulation device 10/20 described in the above-mentioned embodiments can be implemented through execution of a previously prepared program on a computer system such as a personal computer and a workstation. The following describes an example of a computer that executes a computer program having the same functions as those in the biological simulation device as described in the above-mentioned embodiments with reference to FIG. 11. FIG. 11 is a diagram illustrating the computer that executes a biological simulation program.

As illustrated in FIG. 11, a computer 300 includes a plurality of multi-core CPUs 310, a ROM 320, a hard disk drive (HDD) 330, and a RAM 340. These components 310 to 340 are connected to one another via a bus 350. The CPU 310 includes a plurality of cores 310a.

The ROM 320 stores therein a basic program such as an OS. The HDD 330 previously stores therein a biological simulation program 330a exhibiting the same functions as those of the calculator 15a, the first calculator 15b, the second calculator 15c, the first updating unit 15d, and the second updating unit 15e in the above-mentioned first embodiment. Note that the biological simulation program 330a may be separated as appropriate. The biological simulation program 330a may be a computer program exhibiting the same functions as those of the calculator 25a, the first calculator 25b, the second calculator 25c, the third calculator 25d, the first updating unit 25e, and the second updating unit 25f in the above-mentioned second embodiment.

The CPUs 310 load the biological simulation program 330a from the HDD 330 and execute it.

The above-mentioned biological simulation program 330a is not necessarily stored in the HDD 330 initially.

For example, the computer 300 may load the biological simulation program 330a from the biological simulation program 330a stored in a “mobile physical medium” such as a flexible disk (FD), a compact disk read only memory (CD-ROM), a digital versatile disk (DVD), a magnetooptical disk, and an IC card that is inserted into the computer 300, and execute it.

Furthermore, the computer 300 may load the biological simulation program 330a from the biological simulation program 330a stored in “another computer (or server)” that is connected to the computer 300 through a public line, the Internet, a LAN, a wide area network (WAN), or the like, and execute it.

An accurate simulation result can be obtained.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable storage medium having stored therein a biological simulation program that causes a computer to execute a process comprising:
calculating a behavior of a material contained in a cell of an organ of a biological body;
calculating a behavior of the cell based on the calculated behavior of the material;
calculating a behavior of the organ based on the calculated behavior of the cell;
reflecting the calculated behavior of the organ to the behavior of the cell; and
reflecting the behavior of the cell to which the behavior of the organ has been reflected to the behavior of the material.

2. A computer-readable storage medium having stored therein a biological simulation program that causes a computer to execute a process comprising: calculating a behavior of a material contained in a cell of an organ of a biological body;
calculating a force that is applied to the organ;
calculating a behavior of the organ based on the calculated force that is applied to the organ;
calculating a behavior of the cell based on the calculated behavior of the material;
reflecting the calculated behavior of the organ to the cell; and
reflecting the behavior of the cell to which the behavior of the organ has been reflected to the behavior of the material.

3. The computer-readable storage medium according to claim 2, wherein
the computer includes a first processor and a second processor,
the biological simulation program causes:
the first processor to calculate the behavior of the organ, and
the second processor to calculate the behavior of the material, calculate the force that is applied to the organ, calculate the behavior of the cell, reflect the calculated behavior of the organ to the cell, and reflect the behavior of the cell to which the behavior of the organ has been reflected to the behavior of the material.

4. A biological simulation method comprising:
calculating a behavior of a material contained in a cell of an organ of a biological body;
calculating a behavior of the cell based on the calculated behavior of the material;
calculating a behavior of the organ based on the calculated behavior of the cell;
reflecting the calculated behavior of the organ to the behavior of the cell; and
reflecting the behavior of the cell to which the behavior of the organ has been reflected to the behavior of the material.

5. A biological simulation method comprising:
calculating a behavior of a material contained in a cell of an organ of a biological body;
calculating a force that is applied to the organ;
calculating a behavior of the organ based on the calculated force that is applied to the organ;
calculating a behavior of the cell based on the calculated behavior of the material;
reflecting the calculated behavior of the organ to the cell; and
reflecting the behavior of the cell to which the behavior of the organ has been reflected to the behavior of the material.

6. A biological simulation device comprising:
a first processor configured to calculate a behavior of a material contained in a cell of an organ of a biological body, calculate a behavior of the cell based on the calculated behavior of the material, reflect a behavior of the organ to the behavior of the cell, and reflect the behavior of the cell to which the behavior of the organ has been reflected to the behavior of the material; and
a second processor configured to calculate a behavior of the organ based on the calculated behavior of the cell.

7. A biological simulation device comprising:
a first processor configured to calculate a behavior of a material contained in a cell of an organ of a biological body, calculate a behavior of the organ based on the calculated force that is applied to the organ, calculate a behavior of the cell based on the calculated behavior of the material, reflect the calculated behavior of the organ to the cell, and reflect the behavior of the cell to which the behavior of the organ has been reflected to the behavior of the material; and
a second processor configured to calculate a force that is applied to the organ.

8. The biological simulation device according to claim 7, wherein any of the calculation of the behavior of the material contained in the cell of the organ of the biological body, the calculation of the behavior of the organ based on the calculated force that is applied to the organ, the calculation of the behavior of the cell based on the calculated behavior of the material, the reflection of the calculated behavior of the organ to the cell, and the reflection of the behavior of the cell to which the behavior of the organ has been reflected to the behavior of the material by the first processor and the calculation of the force that is applied to the organ by the second processor are executed in parallel.
